(19) United States
(12) Patent Application Publication
(10) Pub. No.: US 2009/0286652 A1
(43) Pub. Date: Nov. 19, 2009

(54) System and Method for Starting a Combustion Engine of a Hybrid Vehicle

(76) Inventors: Philippe Noel, Beloeil (CA); Ghislain Lambert, Beloeil (CA); Maalainine El Yacoubi, Longueil (CA); Jean-Marc Cyr, Candiac (CA); Martin Houle, Laval (CA)

Correspondence Address: FULBRIGHT & JAWORSKI L.L.P., 600 CONGRESS AVE., SUITE 2400, AUSTIN, TX, 78701, US

(21) Appl. No.: 12/510,095

(22) Filed: Jul. 27, 2009

Related U.S. Application Data
(62) Division of application No. 10/591,382, filed on May 21, 2007.

(30) Foreign Application Priority Data
Mar. 4, 2004 (CA) 2,459,696

(51) Int. Cl. F02N 11/08

(52) U.S. Cl. 477/167; 903/946

(57) ABSTRACT

A system and method for starting an ICE of a hybrid vehicle, the hybrid vehicle having a generator with a rotor rotating at an angular speed and a clutch provided between the ICE and the rotor. The method includes steps of disengaging the clutch so that the rotor and the ICE can operate independently; increasing the angular speed; upon the angular speed reaching a predetermined speed, engaging the clutch; allowing the ICE to crank; and starting the ICE.

### FIELD OF THE INVENTION

The present invention relates to a system and a method for starting a combustion engine of a hybrid vehicle. More specifically, the present invention is concerned with such a method and system wherein the combustion engine can be started without requiring an operational high-voltage battery.

### BACKGROUND OF THE INVENTION

Series hybrid vehicles typically include an internal combustion engine (ICE), a generator, a high-voltage bus, a high-voltage battery and an electric motor. The ICE is linked to the generator, which is in turn connected to the high-voltage bus. The high-voltage bus is further connected to the high-voltage battery and to the electric motor. When the ICE is in operation, it drives the generator, which produces an electric current that can be used to recharge the high-voltage battery through the high-voltage bus. Also, the electric motor can accept the electric current produced by the generator to provide propulsive power to the vehicle.

In addition, series hybrid vehicles typically include a low-voltage battery connected to the high-voltage bus through a dc-dc converter to be recharged thereby. This low-voltage battery is in turn connected to a low-voltage bus and a current provided by the low-voltage battery is used to power accessories through the low-voltage bus.

Parallel hybrid vehicles are very similar to the above discussed series hybrid vehicle with the notable difference that the ICE may be directly coupled to the driving wheels.

Since hybrid vehicles include a high-voltage battery, the ICE is not necessarily always running. Indeed, when the high voltage battery contains a sufficient charge, it can be used to solely power the vehicle.

The generator coupled to the ICE can be operated in reverse to function as a motor, there is therefore no need for a separate starter motor to start the ICE on such hybrid vehicles since the generator can be used for this task. Indeed, when there is a need to start the ICE, the generator is used as a starter to crank the shaft of the ICE to thereby start the ICE.

Therefore, since there is no starter in such hybrid vehicles, if the high-voltage battery is non-operational, the ICE cannot be started. Then, the vehicle may need to be towed to a service point, or the high-voltage battery needs to be recharged through external means to render the hybrid vehicle operational. This situation is highly undesirable because the ICE, if started, could often provide enough power to the electric motor, or directly to the wheels, through the generator to move the hybrid vehicle to the service point.

Against this background, there exists a need in the industry to provide a novel system and method for starting an ICE of a hybrid vehicle.

### OBJECTS OF THE INVENTION

An object of the present invention is therefore to provide an improved system and a method for starting an ICE of a hybrid vehicle.

### SUMMARY OF THE INVENTION

More specifically, in accordance with an aspect of the present invention, there is provided a hybrid vehicle comprising:

an ICE;

an electric generator linked to the ICE;

a traction motor connected to at least a wheel of the vehicle;

a low voltage battery; and

a reversible dc-dc converter interconnecting the low voltage battery to the electric generator;

wherein when said ICE has to be started, low voltage from said low voltage battery is converted to high voltage by said reversible dc-dc converter and supplied to said electric generator that is used as an electric motor to crank the ICE.

According to another aspect of the present invention, there is provided a method for starting an ICE of a hybrid vehicle, the hybrid vehicle having an electric generator and a clutch selectively linking the ICE and the electric generator, said starting method comprising:

disengaging the clutch so that the electric generator and the ICE can operate independently;

increasing an angular speed of the generator;

upon the angular speed reaching a predetermined speed, engaging the clutch; and

cranking and starting the ICE.

According to another aspect of the present invention, there is provided a method for starting an ICE of a hybrid vehicle, the hybrid vehicle having a generator linked to the ICE, a high voltage battery, a low voltage battery and a reversible dc-dc converter provided between the generator and the low-voltage battery, said method comprising:

detecting a failure of the high-voltage battery;

upon detection of the battery failure; supplying the generator with energy from the low voltage battery via the reversible dc-dc converter; and

cranking and starting the ICE.

It is to be noted that the expression “battery failure” is to be construed herein and in the appended claims as either a battery that is in a depleted state or a battery that is otherwise not operational.

### BRIEF DESCRIPTION OF THE DRAWINGS

In the appended drawings:

FIG. 1 is a schematic block diagram of a series hybrid vehicle;

FIG. 2 illustrates a method for starting an ICE of a hybrid vehicle according to a first embodiment of the present invention;

FIG. 3 is a schematic block diagram of a series-parallel hybrid vehicle; and

FIG. 4 illustrates a method for starting an ICE of a hybrid vehicle according to a second embodiment of the present invention.

### DETAILED DESCRIPTION

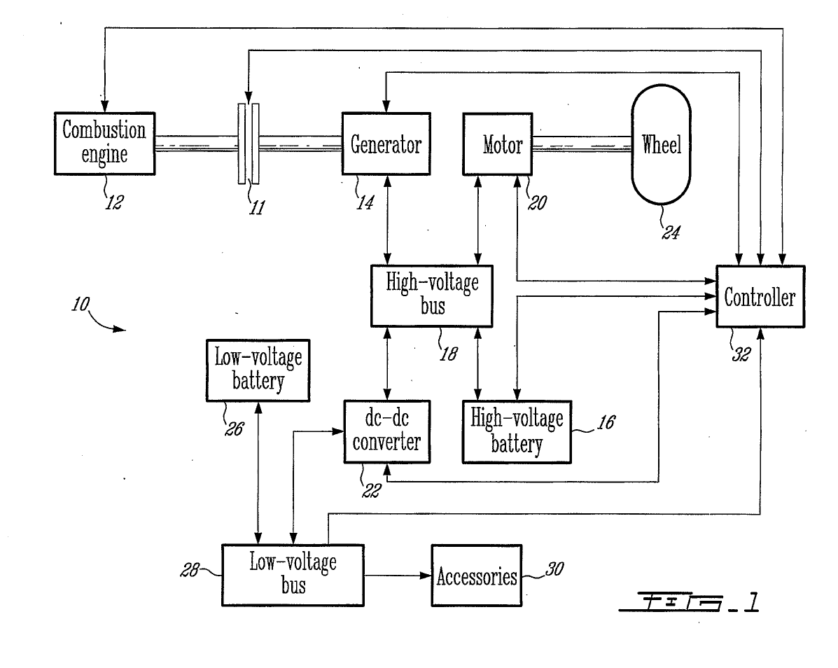

FIG. 1 schematically shows a block diagram of a series hybrid vehicle 10. The hybrid vehicle 10 shown on FIG. 1 is a hybrid car having a plurality of wheels, at least one of which is a propulsive wheel 24. However, the reader skilled in the art will readily appreciate that the system and method described hereinbelow is also applicable to other types of hybrid vehicles such as boats, trains, motorcycles, trucks, and buses, for example.

The hybrid vehicle 10 includes an ICE 12 selectively linked through a clutch 11 to a rotor (not shown) of a generator 14. The generator 14 further includes a stator (not shown). Therefore, the ICE 12 and the generator 14 can be interlinked or unlinked. The ICE 12 can be any ICE such as a gas engine, a diesel engine or a turbine, among others. The generator 14 is connected to a high-voltage battery 16 through a high-voltage bus 18. The high-voltage bus 18 is also connected to an electric traction motor 20 and to a dc-dc converter 22. The electric traction motor 20 is connected to the wheel 24 while the dc-dc converter 22 is indirectly connected to a low-voltage battery 26. The low-voltage battery 26 provides a low-voltage current to a low-voltage bus 28 to power accessories 30 of the hybrid vehicle 10.

Finally, an energy management controller 32 is connected to the electric motor 20, the generator 14, the clutch 11, the ICE 12, the high-voltage battery 16, the dc-dc converter 22 and the low-voltage bus 28. Of course, the energy management controller 32 could be part of a general controller that manages the operation of the hybrid vehicle 10.

In a specific example of implementation, the low-voltage battery 26 and low-voltage bus 28 operate at the voltage of 12 volts. In this example, the high-voltage bus 18 and the high-voltage battery 16 operate at a high voltage of 300 volts. However, these values are only examples and any other suitable values for the low voltage and the high voltage can be used with the present invention.

It is believed that the ICE 12, the electric generator 14, the electrically controlled clutch 17, the electric motor 20, the dc-dc converter 22, the wheel 24, the high-voltage bus 18, the high-voltage battery 16, the low-voltage battery 26, the low-voltage bus 28 and the accessories 30 are well known in the art. Therefore, they will not be described in details hereinbelow. However, it must be understood that the ICE 12, the generator 14, the clutch 17, the electric motor 20, the dc-dc converter 22 and the high-voltage battery 16 are advantageously “intelligent” devices that can receive commands from and/or provide data to the controller 32. Examples of these commands and data, and the manner into which they are sent to or received from the controller 32 are described in further details hereinbelow.

When there is a need to use the generator 14 to generate electricity, for example to recharge the high voltage battery 16, the clutch 11 is engaged and the ICE 12 is started by the generator 14, then used as an electric motor powered by the high-voltage battery 16 via the high voltage bus 18. Then, the ICE 12 runs and provides mechanical power to the generator 14 to rotate its rotor. This causes the generator 14 to provide electrical power to the high-voltage bus 18. When the generator 14 is providing power to the high-voltage bus 18, the high-voltage battery 16 can be recharged and the electric traction motor 20 can get power from the high-voltage bus 18 to provide propulsive power to the wheel 24.

The dc-dc converter 22 may use a portion of the high-voltage current from the high-voltage bus 18 and converts it to a low-voltage current that can be fed to the low-voltage battery 26. The low-voltage battery 26 can power the accessories 30 and the controller 32 through the low-voltage bus 28.

The controller 32 manages the above-described operation of the hybrid vehicle 10. In addition, the controller 32 implements a method for starting the hybrid vehicle 10. Generally stated, one embodiment of the method includes steps of disengaging the clutch 11 so that the generator 14 and the ICE 12 can operate independently; increasing an angular speed of the rotor of the generator 14; and engaging the clutch 11 when the angular speed reaches a predetermined speed. The method further includes steps of allowing the ICE to crank and of starting the ICE. The method is described in further details hereinbelow.

As will be apparent to one skilled in the art, the controller 32 includes a processing unit, memory and multiple input/output (I/O) ports connecting it to the other elements of the vehicle 10.

The memory contains a program element implementing a method for starting the hybrid vehicle to be executed by the processing unit. To implement the method, the processing unit can exchange various signals indicative of data and commands with the components of the hybrid vehicle 10 through the various ports.

It is to be noted that the dc-dc converter 22 is a so-called reversible dc-dc converter. In other words, the controller 32 may issue a command signal instructing the dc-dc converter 22 to convert high-voltage current coming from the high-voltage bus 18 to a low-voltage current to be fed to the low-voltage battery 26. Alternatively, the dc-dc converter 22 can be controlled by the controller 32 to convert a low-voltage current incoming from the low-voltage battery 26 to a high-voltage current to be fed to the high-voltage bus 18.

It is also to be noted that there may be a need to provide a selective energy blocking element (not shown), such as a diode or a contactor, between the high voltage battery 16 and the high voltage bus 18 to prevent high voltage fed to the high voltage bus 18 from the dc-dc converter 22 from recharging the high voltage battery 16.

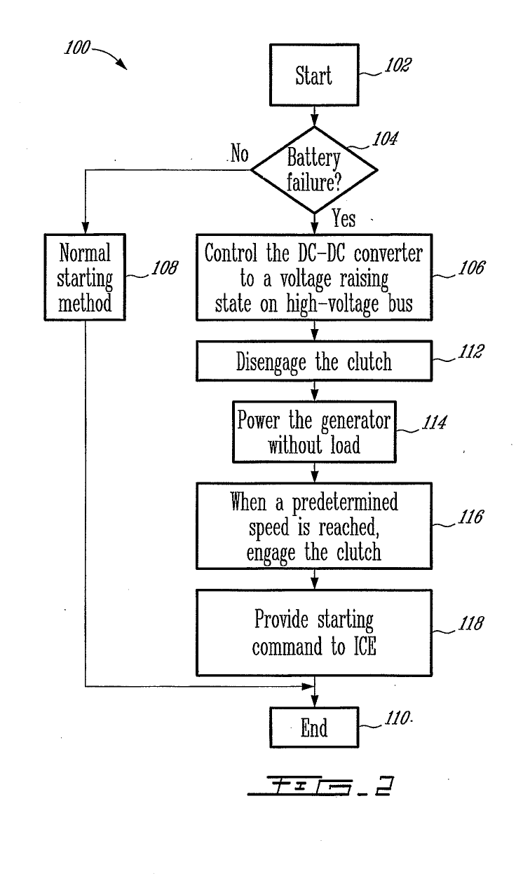

The program element contained in the memory implements the following method 100 for starting the hybrid vehicle 10 upon a failure of the high-voltage battery 16. The method 100, illustrated in FIG. 2, can also be used when the high-voltage battery 16 is still functional but is in a low charge status.

The method 100 starts at step 102. At step 102, the ICE 12 is not running and there is a need to run the ICE 12 to provide mechanical power to the generator 14.

At step 104, the controller 32 detects either the failure or the low charge status of the high-voltage battery 16. The method 100 branches to step 106, described hereinbelow, if the amount of energy stored in the high-voltage battery 16 if below a predetermined level. Otherwise, a standard method for starting the ICE 12 is performed at step 108 and the method ends at step 110. This standard method is believed known and generally involves the use of the generator 14 as a starting motor.

At step 106, the controller 32 instructs the dc-dc converter 22 to switch to a voltage raising state wherein the dc-dc converter 22 converts a low-voltage current incoming from the low-voltage battery 26 to a high-voltage current to be provided to the high-voltage bus 18.

At step 112, the clutch 11 is disengaged. It is to be noted that step 106 and step 112 may be done simultaneously or in any order.

At step 114, the generator 14 is controlled as a motor and uses the high-voltage current present on the high-voltage bus 18 to rotate the rotor of the generator 14. Since the generator 14 is not linked to the ICE 12 at that time, the rotor of the generator 14 starts rotating in an unloaded condition. The high-voltage current fed to the generator 14 gradually increases the angular speed of the generator 14. Angular speed data is sent to the controller 32.

When a predetermined angular speed is reached, the rotational energy stored into the rotor inertia is used to crank the ICE 12 by engaging the clutch 11 (step 116). A command instructing the engagement clutch 11 is sent to the clutch 11 by the controller 32. The clutch 11 can be either rapidly engaged or slowly engaged. In the first case, the clutch 11, the generator 14 and the ICE 12 must be sturdy enough to withstand an abrupt engagement of the clutch 11. In the second case, the engagement of the clutch 11 is less demanding on the mechanical strength of the ICE 12, the clutch 11 and the generator 14. However, the generator 14 then typically needs to rotate at a faster angular speed than in the first case prior to the engagement of the clutch 11 as some energy is lost through friction.

In step 118, the controller 32 sends commands regarding the starting and firing of the ICE 12. Therefore, the ICE 12 can be started using energy stored into the rotor of the generator and the method 100 ends at step 110.

Since the ICE 12 is then running, the hybrid vehicle 10 can be moved and the high-voltage battery 16 can either be recharged through the generator 14 or brought to a service center so that the high-voltage battery 16 can be exchanged or repaired.

In other words, the method 100 makes use of energy stored into the low-voltage battery 26 to rotate the rotor, thereby storing kinetic energy. This kinetic energy is in turn used to crank the ICE 12.

It is to be noted that while the angular speed data may be sent to the controller 32 as mentioned hereinabove, this is not essential. Indeed, the controller could be configured to let the generator be powered (step 114) for a predetermined duration before the clutch is engaged (step 116). This way, no angular speed sensor would be required.

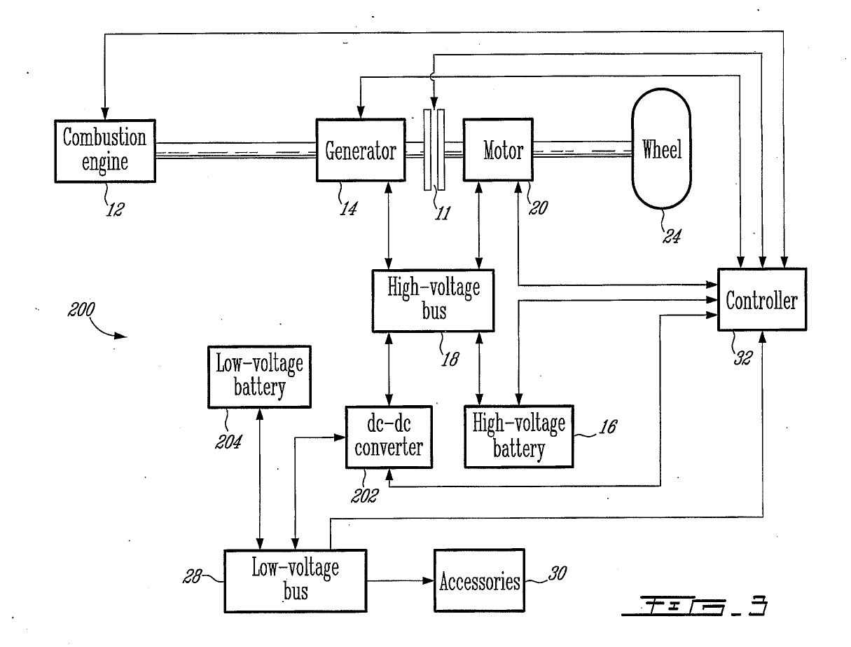

Turning now to FIG. 3 of the appended drawings, a series-parallel hybrid vehicle 200 will be briefly described. It is to be noted that the elements of the vehicle 200 that are similar to the elements of the vehicle 10 of FIG. 1 keep the reference number of FIG. 1. It is also to be noted that since the vehicle 200 is very similar to the vehicle 10, only the differences between these two vehicles will be described hereinbelow.

The main difference between the vehicle 200 and the vehicle 10 concerns the clutch 11 that has been moved from its location between the ICE 12 and the generator 14 to a location between the generator 14 and the traction motor 20. Accordingly, when the clutch 11 is disengaged, the vehicle 200 is in a series hybrid mode and when the clutch 11 is engaged, the vehicle 200 is in a parallel hybrid mode. Indeed, when the clutch 11 is engaged, both the ICE 12 and the traction motor 20 supply torque to the wheel 24.

The other difference between the vehicles 10 and 200 is that the dc-dc converter 202 and the low voltage battery 204 of the vehicle 200 are powerful enough to supply sufficient high current voltage from the low voltage bus 28 to the high voltage bus 18 to allow the generator to directly crank and start the ICE 12. Therefore a clutch is not required between the ICE 12 and the generator 14.

Of course, should that not be the case a second clutch (not shown) could be mounted between ICE 12 and the generator 14.

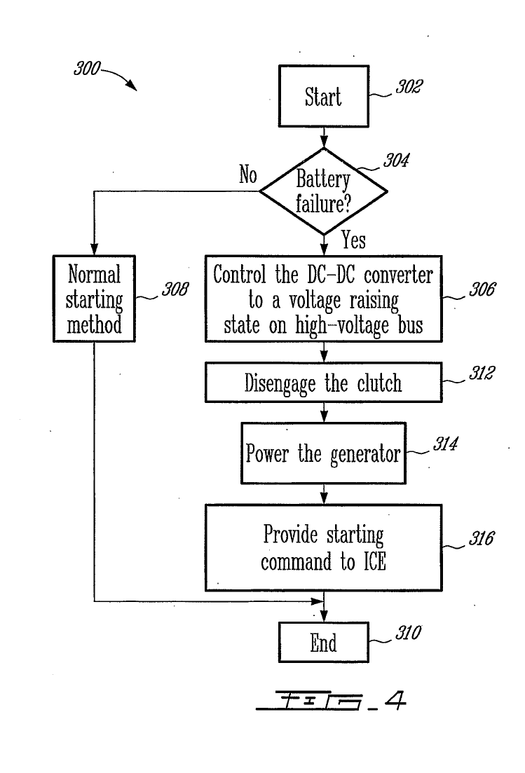

Turning now to FIG. 4 of the appended drawings, a corresponding method 300 to start the ICE 12 will be described.

The method 300 starts at step 302. At step 302, the ICE 12 is not running and there is a need to run the ICE 12 to provide mechanical power to the generator 14 and/or to the wheel 24.

At step 304, the controller 32 detects either the failure or the low charge status of the high-voltage battery 16. The method 300 branches to step 306, described hereinbelow, if the amount of energy stored in the high-voltage battery 16 if below a predetermined level. Otherwise, a standard method for starting the ICE 12 is performed at step 308 and the method ends at step 310.

At step 306, the controller 32 instructs the dc-dc converter 202 to switch to a voltage raising state wherein the dc-dc converter 202 converts a low-voltage current incoming from the low-voltage battery 204 to a high-voltage current to be provided to the high-voltage bus 18.

At step 312, the clutch 11 is disengaged to thereby endure that the generator 14 does not power the wheel 24. It is to be noted that step 306 and step 312 may be done simultaneously or in any order.

At step 314, the generator 14 is controlled as a motor and uses the high-voltage current present on the high-voltage bus 18 to rotate the rotor of the generator 14.

Finally, in step 316, the controller 32 sends commands regarding the starting and firing of the ICE 12.

Since the ICE 12 is then running, the hybrid vehicle can be moved and the high-voltage battery 16 can either be recharged through the generator 14 or brought to a service center so that the high-voltage battery 16 can be exchanged or repaired.

Many variations can be brought to the above described hybrid vehicles and methods without detracting from the present invention.

In a variant, the engagement and disengagement of the clutch 11 is powered by any of the known methods in the art for engaging and disengaging clutches, such as through a hydraulic circuit or a magnetic field, among others. Alternatively, the controller 32 does not control the clutch 11. In this case, an indicator controlled by the controller 32 indicates to a user of the electric vehicle that the clutch 11 needs to be engaged and/or disengaged by the user.

In a further variant, an alternative clutch (not shown) is disengaged each time that the ICE 12 is stopped. This can be advantageous as the alternative clutch can then be conceived such that only a very small amount of energy is required for engagement. For example, the alternative clutch may store energy when disengaging, such as through a spring, and may then be locked in the disengaged state. By subsequently unlocking this alternative clutch, the alternative clutch can become engaged without requiring any energy other than the energy required to unlock the alternative clutch.

Also, the predetermined speed of rotation can be replaced by a variable depending on many parameters such as a temperature of an environment into which the hybrid vehicle 10 is located, a charge of the low-voltage battery 26, and a number of times the methods described hereinabove have been tried without success, among others.

Although the present invention has been described hereinabove by way of preferred embodiments thereof, it can be modified, without departing from the spirit and nature of the subject invention as defined in the appended claims.

1-3. (canceled)

4. A method for starting an ICE of a hybrid vehicle, the hybrid vehicle having an electric generator and a clutch selectively linking the ICE and the electric generator, said starting method comprising:
disengaging the clutch so that the electric generator and the ICE can operate independently;
increasing an angular speed of the generator;
upon the angular speed reaching a predetermined speed, engaging the clutch; and
cranking and starting the ICE.

5. A method as recited in claim 4, wherein said angular speed increasing includes supplying high voltage to the generator.

6. A method as recited in claim 5, wherein said high voltage supplying includes converting low voltage coming from a low voltage battery to high voltage via a reversible dc-dc converter.

7.-9. (canceled)
